(19) United States
(12) Patent Application Publication
(10) Pub. No.: US 2018/0144403 A1
(43) Pub. Date: May 24, 2018

(54) SELECT GROUP CROWDSOURCE ENABLED SYSTEM, METHOD AND ANALYTICAL STRUCTURE TO PERFORM SECURITIES VALUATIONS AND VALUATION ADJUSTMENTS AND GENERATE DERIVATIVES THEREFORM

(71) Applicant: DANIEL HEIMOWITZ, NEW YORK, NY (US)

(72) Inventor: DANIEL HEIMOWITZ, NEW YORK, NY (US)

(21) Appl. No.: 15/356,718

(22) Filed: Nov. 21, 2016

(51) Int. Cl. G06Q 40/04; G06Q 40/02

(52) U.S. Cl. CPC G06Q 40/04; G06Q 40/02

(57) ABSTRACT

A select group, crowd-sourced enabled system, method and analytical structure to perform securities valuations and valuation adjustments thereof and generate derivatives therefrom is disclosed. The system is supplied with data generated by and from selected crowd-sourced entities. A computer retrieves and processes the data to perform an analysis according to a series of mapping points and criteria as a function of risk, asset class, issue name, coupons, maturity data, identification numbers, issuer data and other analytical determinants to generate a relative and absolute risk grade for each security. The system may then generate risk grades for baskets of securities and permit the establishment of derivatives (contracts) based upon an aggregate risk grade, which derivatives may be traded separate from the underlying securities.

### FIELD OF THE INVENTION

The present invention is related to computer systems which allow users to employ, access and update vital securities market data, and particularly to systems that allow real-time updating and retrieval of crowd-sourced data from multiple pre-vetted market data sources such as analysts, credit analysts, market participants and other researchers. The present invention relates to securities valuation and securities valuation adjustment techniques. In particular, the present invention relates to systems and methods to perform debt securities (and variants of debt securities) valuation and valuation adjustment analyses. The disclosure relates generally to using data processing systems for analytics and, in particular, to managing improvements for crowd-sourced analytics. Still more particularly, the present disclosure relates to using crowdsourcing to perform specified tasks associated with improving the effectiveness of debt valuation analysis and valuations that are generated by unique consensus values and grades for underlying securities and baskets of securities.

### BACKGROUND OF THE INVENTION

It is well recognized that securities with debt components, municipal bonds and high yield bonds (among other securities that are traded in less than ideally liquid market, hereinafter also referred to as “Credit Related Securities”) change prices constantly and are often difficult to value. In order to keep up with the changes in the price and demand for Credit Related Securities, brokers, traders, salespeople, researchers, portfolio managers and other market participants seek up-to-date securities market information. Securities market information aids these market participants in deciding whether to hold, purchase or sell a particular Credit Related Security. Brokers, traders, salespeople, researchers, portfolio managers and other market participants need to know the accurate price and demand for an individual Credit Related Security.

Each Credit Related Security is unique. The securities market variables which may affect the price and demand for one particular Credit Related Security may not affect the price and demand for another Credit Related Security. Therefore, it is critical that brokers, traders, salespeople, researchers, portfolio Managers and other market participants have access to a wide array of securities and credit market information as quickly as possible and that such information be presented in a manner that provides some degree of uniformity in permitting the valuation of different Credit Related Securities to be assessed against one another.

Securities market information encompasses several types of information that may affect the price or demand of a Credit Related Security. This information may be grouped into three categories: financial, descriptive and market data. Financial data may include information concerning revenue, earnings before interest, tax, depreciation, amortization and special charges (EBITDA), and leverage ratio (Debt/EBITDA). In the area of municipal bonds it also may include information relating to the creditworthiness of the issuing entity, its assets and cash flow available to pay premiums and principal (e.g., are the payments from sales tax? Are the bonds general obligation or only related to a specific revenue from a specific asset—Triborough Bridge bonds). Descriptive data includes, but is not limited to, S&P rating, Moody's rating, amount outstanding, coupon rate, maturity, and related statistics. Market related data includes, but is not limited to, last price, last yield to worst and spread to worst. Data that may be considered in both categories may be whether the bond is insured or there is other credit support and, if so, the creditworthiness of the supporting entity.

A variety of research firms, financial market sources (e.g. NYSE, AMEX, Nasdaq-FIPS), and pricing firms (e.g. Interactive Data Corporation (IDC) and Muller Data) collect securities market pricing and other information. In turn, brokers, traders, salespeople, researchers, portfolio managers and other market participants rely on financial market sources and pricing firms to obtain the latest securities market information collected from that particular source.

Presently, brokers, traders, salespeople, researchers, portfolio managers and other market participants rely principally on each other (other market participants) to determine the fair value of a security or bond via telephonic communication. This method is very time consuming, labor intensive and inexact. In fact, many over-the-counter markets still work as they did over twenty years ago—when a trader or salesperson wants to communicate market information or “color” to his/her co-workers, he/she simply stands up and shouts it to his co-workers. This method of obtaining and sharing securities market information is also limiting because brokers, traders, salespeople, researchers, portfolio managers and other market participants may only obtain a limited amount of information from the limited number of people that he/she can manually query. Further, brokers, traders, salespeople, researchers, portfolio managers and other market participants must contact several different sources to obtain different types of securities market information. This type of researching can take hours, or even days, which creates the possibility for extremely costly lost opportunities within financial markets.

Currently, there are three major purveyors of financial information concerning securities on the basis of installed terminals: Reuters, Bloomberg, and Bridge (there are other purveyors in limited areas with concomitant limited information). All three services offer Internet-based versions of their products. These services allow their users access to certain types of financial information that is maintained within their system. However, these services are limited in their ability to display financial information concerning a particular security, because they only display information from one pricing source at a time. A broker, trader, salesperson, researcher, portfolio manager or other market participant that uses one of these services would have to conduct multiple time consuming searches to obtain different types of pricing and descriptive information. Also, these three sources do not display co-mingled pricing information.

In today's fast pace Credit Related Securities markets, the challenge for brokers, traders, salespeople, researchers, portfolio managers and other market participants is to obtain all available securities market information as quickly and efficiently as possible. Although a number of patents, such as U.S. Pat. No. 5,101,353, to Lupien et al., U.S. Pat. No. 5,915,245, to Patterson, Jr. et al., U.S. Pat. No. 5,826,244, to Huberman, U.S. Pat. No. 5,991,751 to Rivette et al., and U.S. Pat. No. 5,592,375 to Salmon et al. disclose automated systems for trading and valuing securities, the above-mentioned patents do not provide access to a variety of securities market information in one central system that permits the aggregation and normalization of Credit Related Securities' data and multi-party contribution to that data. The current invention allows brokers, traders, salespeople, researchers, portfolio managers and other market participants to access and search, in one central standardized database, Credit Related Security normalized and consensus market pricing, descriptive and financial information from a variety of external and internal (via “groupware” and “crowdsourcing” features) sources in real-time, thus quickly providing brokers, traders, salespeople, researchers, portfolio managers and other market participants with critical information.

Advances in fixed income securities and markets have led to the widespread availability of a number of different types of products. Many investors and institutions (generally referred to herein as “Investors”) hold a number of different positions in fixed income securities and fixed income derivatives. For example, a typical institutional investor may hold a number of different derivative positions, many of which may be with different counterparties. The availability of new derivative markets and issues has made it easy for investors to invest and diversify.

Unfortunately, however, the wide availability of different issues and markets can also make it difficult for investors to assess the overall value and potential risk due to counterparty specific credit risk associated with their derivative portfolio. Further, it is also difficult to assess the impact associated with adding a new position to an existing portfolio. A technique referred to as “credit valuation adjustment” has been used to assist investors in evaluating the value and risk associated with their portfolios. However, these credit valuation adjustments are generally performed using proprietary data and proprietary techniques. It would be desirable to provide a credit valuation adjustment tool which utilizes market data and which results in repeatable analyses, thereby allowing Investors to reliably assess the overall value and risk of existing and proposed investments and derivative positions.

Accordingly, in recent years and continuing into the present, various online systems for the processing of bond transactions in a multi-user environment have been proposed. These systems often generally describe methodologies which comprise databases for debt issues available to be traded and databases about trades of the debt issues, thus providing users access to the issue and trades. An example of such prior art techniques is described below.

U.S. Pat. No. 5,809,483 describes a method and system for reporting the trading of debt issues has been developed which comprises a host processing system containing issue databases having information about debt issues available to be traded, and trade databases containing data about trades of the debt issues available to be traded; and a plurality of user stations, connected to the host processing system, for providing users an ability to access the issue and trade databases, said user stations including display means for displaying data from the issue databases and the trade databases, input means for receiving user inputs about trades of the issues available to be traded and identifying the data from the issue databases and the trade databases to be displayed on the display means for providing to the host processing system the user inputs, and communications means for receiving the data to be displayed from the host processing system and for transmitting the user inputs to the host processing system.

However, this system is emblematic of the deficiencies in the prior art. There is nothing from which a user can determine the relative and absolute value of a security or determine whether any trader of a security is undertaking the purchase or sale based on any factual or relativistic analysis of the security. There is no basis for knowing whether any trader is competent or incompetent and thus the information is little more than a history of the trading in a particular security.

Thus, a continuing need exists for a system that allows system, method and analytical structure to perform securities valuations and valuation adjustments thereof and generate derivatives therefrom. Such a system, method and analytical structure is disclosed herein. The system is supplied with data generated by and from selected crowd-sourced entities. A computer retrieves and processes the data to perform an analysis according to a series of mapping points and criteria as a function of risk, asset class, issue name, coupons, maturity data, identification numbers, issuer data and other analytical determinants to generate a relative and absolute risk grade for each security. The system may then generate derivatives based upon the aggregate risk grade of a basket of Credit Related Securities that are within an asset class (municipals, asset backed securities, etc.) which derivatives may be traded separate from the underlying securities. The present invention fills these and other present needs.

### SUMMARY OF THE INVENTION

It is an object of the present invention to provide an on-line computer server and system for collecting from multiple, pre-vetted crowd-sourced entities Credit Related Security market information in real-time, adjusting and normalizing that Credit Related Security market information and deriving a grade for that Credit Related Security.

It is a further object of the invention to provide a system for automatically updating Credit Related Security market information in real-time without human intervention in the updating process wherein the multiple, pre-vetted crowd-sourced entities continue to supply information and the analytical elements of the system generate continuous updates to the grade for the Credit Related Security, which grade is then disseminated to the crowd-sourced entities and may similarly be disseminated to other entities on a subscription or other basis.

A system according to the invention preferably maintains communication links with multiple, pre-vetted crowd-sourced entities that contribute data to the system, which links may either be via a communication link, a continuous data feed, batch delivery or other data transfer mechanisms.

It is a still further object of the invention is to provide a system, method and analytical structure to conduct multiple analyses of Credit Related Securities market information and display the analytical grading results for each Credit Related Security either virtually instantaneously, with real-time updating, or in a predetermined periodic schedule such that, in either event, each contributing or subscribing entity receives the information at the same time.

It is another object of the invention to allow users of the system to submit and share Credit Related Securities market information with each other on a blind basis for analytical purposes such that no entity is apprised of the specific data provided by another. The system, by normalizing the data against mapping constraints, permits the data to be weighted according to certain predetermined criteria, and then employed to generate a grading for each submitted Credit Related Security. While the system may maintain communication links with users that allow them to contribute data to and view grades for a Credit Related Security, the contributed data is not directly shared and is maintained as confidential to the particular contributor. This permits contributors to provide information that might otherwise be deemed not appropriate for sharing with a competitor or counterparty.

According to embodiments of the present disclosure, disadvantages and problems associated with analyzing Credit Related Securities using data from an individual source or from a limited number of sources may be reduced or eliminated. The data may either be structured (bond ratings, specific maturity dates, etc.) or unstructured (sentiment regarding creditworthiness, political or other issues effecting the Credit Related Security). It is mapped against a set of normalizing criteria that weigh the extent to which the data will be employed in determining a grade for a specific Credit Related Security or a number of similar Credit Related Securities.

In certain embodiments, unstructured data is received from a plurality of pre-vetted crowd-sourced entities to facilitate credit and concomitant risk analysis. The unstructured data is converted into a structured form through the mapping function and the resultant data is then employed to generate a grade for one or more Credit Related Securities.

Certain embodiments of the present disclosure may provide one or more technical advantages. A technical advantage of one embodiment includes extracting, analyzing, and summarizing useful information from various crowd-sourced entities to evaluate credit risks. Another technical advantage of an embodiment includes transforming multi sourced unstructured data into a normalized structured form to determine provide a grading element to risk.

Currently there is no system or process available for creating and submitting crowd-sourced Credit Related Securities and derivatives valuations to trading entities and Investors.

Therefore, it would be advantageous to have a method, data processing system, and computer program product that takes into account at least some of the issues discussed above, as well as possibly other issues.

In one illustrative embodiment, more fully set forth below, a method, data processing system, and computer program product for managing analysis of Credit Related Securities and derivatives valuations is disclosed. The data processing system analyzes the data and continues to perform the analysis to determine if a gap exists due to new normalized data thus requiring further processing to improve the analysis of the Credit Related Securities and derivatives valuations. The data processing system then uses crowdsourcing to submit the generated task for processing.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

FIG. 1 is a diagrammatic representation in block diagram form of an example of a flow configuration of a Credit Related Securities and derivatives valuations system and methodology in accordance with an embodiment of the invention.

FIG. 2 is a diagrammatic representation of an example of a generalized derivative generation module and system in accordance with an embodiment of the invention.

FIG. 3 is diagrammatic representation illustrating the compilation of data and analysis thereof for evaluation the risk of Credit Related Securities and assignment of relativistic and absolute grades to a Credit Related Security using the data collection and analysis system in accordance with an embodiment of the invention.

FIG. 4 is a flowchart illustrating a value adjustment by the system of the risk of Credit Related Securities and assignment of adjusted relativistic and absolute grades to a Credit Related Security using the data collection and analysis system in accordance with an embodiment of the invention.

### DETAILED DESCRIPTION OF A PREFERRED EMBODIMENT

Certain terminology may be used in the following description for convenience only and is not limiting. For example, the words “lower” and “upper” and “top” and “bottom” designate directions only and are used in conjunction with such drawings as may be included to fully describe the invention. The terminology includes the above words specifically mentioned, derivatives thereof and words of similar import.

Where a term is provided in the singular, the inventor also contemplates aspects of the invention described by the plural of that term. As used in this specification and in any claims, the singular forms “a”, “an”, and “the” include plural references unless the context clearly dictates otherwise, e.g. “a derivative work”. Thus, for example, a reference to “a method” includes one or more methods, and/or steps of the type described therein and/or which will become apparent to those persons skilled in the art upon reading this disclosure.

Unless defined otherwise, all technical, legal, copyright related and scientific terms used herein have the same meaning or meanings as commonly understood by one of ordinary skill in the art to which this invention belongs. Although any methods and materials similar or equivalent to those described herein can be used in the practice or testing of the present invention, the preferred methods, constructs and materials are described herein. All publications mentioned herein, whether in the text or by way of numerical designation, are incorporated herein by reference in their entirety. Where there are discrepancies in terms and definitions used by reference, the terms used in this application shall have the definitions given herein.

The term “variation” of an invention includes any embodiment of the invention, unless expressly specified otherwise.

A reference to “another embodiment” in describing an embodiment does not necessarily imply that the referenced embodiment is mutually exclusive with another embodiment (e.g., an embodiment described before the referenced embodiment), unless expressly specified otherwise.

The terms “include”, “includes”, “including”, “comprising” and variations thereof mean “including but not limited to”, unless expressly specified otherwise.

The term “consisting of” and variations thereof includes “including and limited to”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The terms “such as”, and/or “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

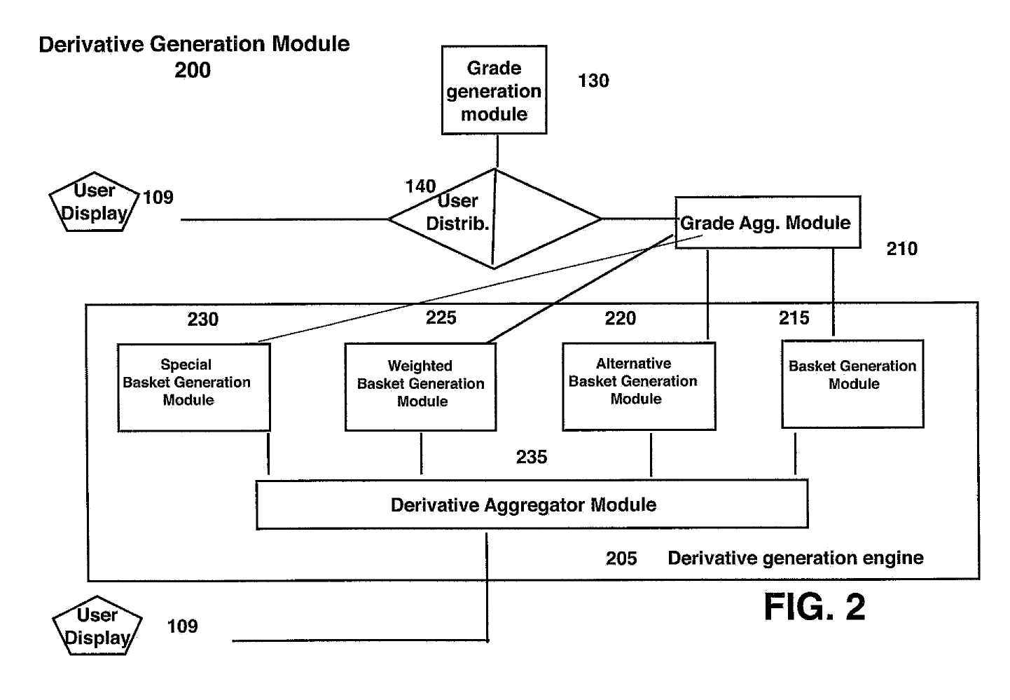

It will be readily apparent to one of ordinary skill in the art that the various processes described herein may be implemented by, e.g., appropriately programmed general purpose computers and computing devices or by general purpose computers that are not necessarily programmed but which may be employed to achieve substantially the same analysis using alternate techniques which are substantially similar to those described herein. Typically a processor (e.g., one or more microprocessors, one or more microcontrollers, one or more digital signal processors) will receive instructions (e.g., from a memory or like device), and execute those instructions, thereby performing one or more processes defined by those instructions. For clarity of explanation, the illustrative system embodiment is presented as comprising individual functional blocks (including functional blocks labeled as a “processor” or “engine”). The functions these blocks represent may be provided through the use of either shared or dedicated hardware, including, but not limited to, hardware capable of executing software. For example, the functions of one or more processors presented in FIG. 2, may be provided by a single shared processor or multiple processors. Use of the term “processor” should not be construed to refer exclusively to hardware capable of executing software. Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

A “processor” includes one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” includes any medium that participates in providing data (e.g., instructions, data structures) that may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The illustrative embodiments recognize and take into account that existing web based applications are available for sharing sentiment information of users. Web based applications typically run on a web server. These web based applications communicate with web browsers and other applications by generating documents such as web pages and sending the documents and other data over a network. The generated web pages are typically displayed on a display screen by a web browser running on a computing device. For example, a web based application for a crowdsourcing platform may generate a web page for a user account for an owner of the user account. In this example, the owner of the user account may make selections for performing and managing tasks in the crowdsourcing platform. For example, responsive to accepting a task, the owner of the user account may provide answers to questions while performing the task, such as by providing data related to aspects of Credit Related Securities.

As used herein, the term “computing device” means a hardware device with a processor unit and a capability to display information on a display device and may also include the capability to emit audio on a speaker. For example, the computing device may be a computer, a television with a processor unit, a smart phone, and any other suitable device.

The illustrative embodiments further recognize and take into account that existing analytics tools for performing natural language processing, computational linguistics, and text analytics are available to identify and extract subjective information in source materials. These analytics tools may be used to identify aspects of Credit Related Securities from information entered by users into social networks and collaboration tools.

Thus, the different illustrative embodiments provide a method, apparatus, and computer program product to manage analysis of aspects of Credit Related Securities.

The analytics management system may analyze the data and aspects of Credit Related Securities to determine if a gap exists requiring further processing to improve the analysis of Credit Related Securities. In this example, the gap corresponds to a topic about a particular aspect of the Credit Related Securities or further data which is required to improve the analysis.

The analytics management system may generate a task to address the gap based on a template corresponding to a type of gap or a deficiency in the data fields necessary to generate a grading number. The analytics management system may also use additional crowdsourcing to submit the generated task for processing to provide the missing data field. After submitting the task for processing, the analytics management system may receive a result of the processing of the task as it relates to one or more Credit Related Securities. Responsive to receiving a result of the processing of the task, the analytics management system may then re-calculate the analysis of based on the result.

It is a further aspect of the invention that the analytics management system may generate a new or revised grade based on a template corresponding to an update of data received from one or more entities or from a recognized third party (e.g., revisions of a debt grade up or down by a rating agency). The analytics management system may also use additional crowdsourcing to submit the update of data received for processing to provide a revised grade for the Credit Related Security. After submitting update of data received for processing, the analytics management system may receive a result of the processing of the task as it relates to one or more Credit Related Securities. Responsive to receiving a result of the processing of the update of data received, the analytics management system may then re-calculate the analysis of based on the result.

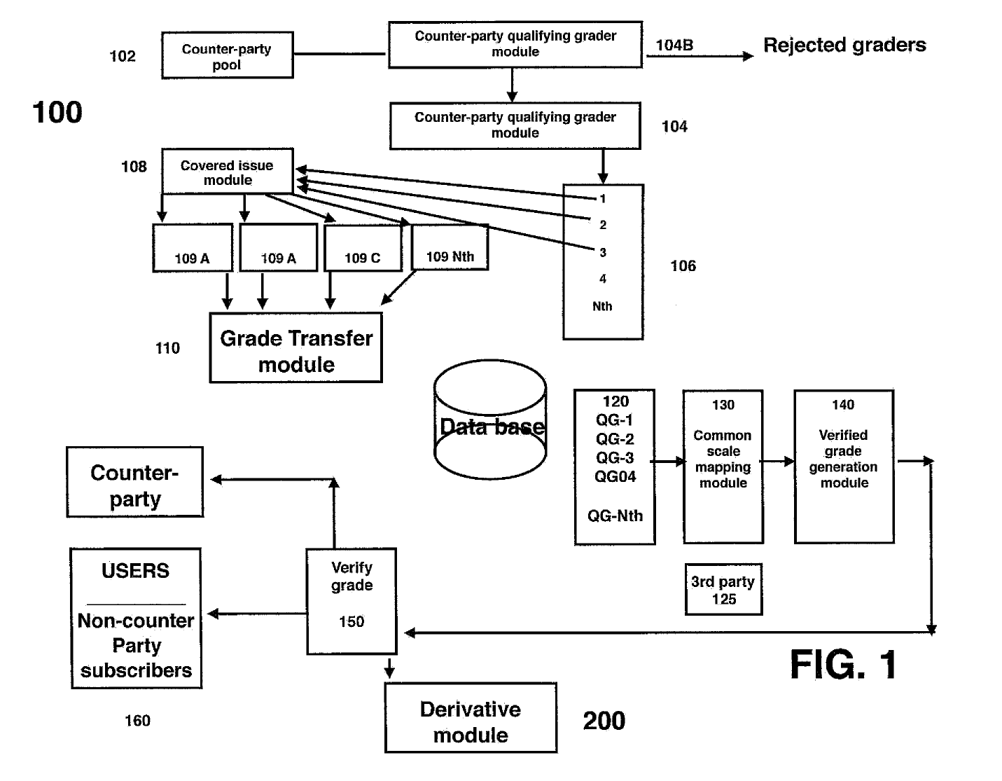

With reference now to the figures and, in particular, with reference to FIG. 1, there is shown an illustration of a crowd-sourced enabled system, method and analytical structure to perform securities valuations and valuation adjustments thereof and generate derivatives therefrom. In this illustrative example, an analytics management environment 100 is depicted in block diagram form.

Some specific terminology will be used to describe the method, system, and computer program product according to the principles of the present invention. These terms are used to describe the concepts that they represent to reduce any ambiguity that may result if the terms are used without such specific definitions. Among the various components and entities that may be a part of system of the instant invention, the following terminology may be advantageously employed:

A. Crowdsourcing is a process for performing certain kinds of tasks. In a crowdsourcing effort or procedure, a large group of organizations, individuals and other entities that desire to provide pertinent services, such as a specific community of providers or the general public, are invited to participate in a task that is presented by a task requester. At present, a crowdsourcing platform may serve as a broker or intermediary between the task requester and providers who are interested in undertaking or participating in task performance.

B. Counterparty can refer to brokers, investment banks, and other securities dealers that serve as the contracting party when completing “over the counter” securities transactions. The term is generally used in this context in relation to “counterparty risk”, which is the risk of monetary loss a firm may be exposed to if the counterparty to an over-the-counter securities trade encounters difficulty meeting its obligations under the terms of the transaction. A counterparty is the other party that participates in a financial transaction, and every transaction must have a counterparty in order for the transaction to go through. More specifically, every buyer of an asset must be paired up with a seller who is willing to sell and vice versa. Inasmuch at the counterparties within any Credit Related Securities field (municipal bonds, CDS, etc.) are those who regularly trade in the securities, they generally form the members of the counterparty pool 102 from which qualified graders 104 are selected.

C. Qualified Graders 104 are individuals and entities who are selected from the counterparty pool 102 based upon a series of criteria. Among those criteria are market presence of the entity, measured by size of holdings or money under management and investment presence within market sectors. Those market sectors may be municipal bonds corporate bonds, asset backed sovereigns and other forms of credit related securities. Further elements of the criteria employed to determine whether the entity employs a formal credit approval and review process to determine valuation and credit worthiness of specific investments within the Credit Related Securities field. Only when an entity is of sufficient size and employs formal evaluation procedures will it be deemed to be a qualified grader 104. It is important to note that the qualified graders 104 are periodically re-qualified based upon the initial criteria that were employed qualify them in the first place and there after as reflected in the market consensus and pricing ultimately generated by the current system. An initial qualified grader 104 whose grades are continuously off mark may ultimately be dropped as a qualified grader whereas one whose grades are consistently reflective of accurate pricing, as indicated by the market may have greater weight attributed to their grades.

D. Grade Mapping is a process by which the grades of the qualified graders 104 are mapped to a common scale of relative risk. This permits the grades to be expressed in a proprietary, numeric scale with the strongest possible credit graded a 10.0 while lesser quality credits will be graded on a continuous scale ranging from 9.9 to 0.1.

E. Issues to be Graded is a process by which each of the qualified graders 104 is provided with a list of the Credit Related Securities and similar fixed income issues and asked to provide a grade for each of the issues which the qualified graders 104 follow. In providing a grade, the qualified graders 104 are asked to contribute that grade as part of the crowd source evaluation. Among the crowd sourced tasks that will be requested of the qualified graders 104, they will be prompted to provide and contribute grades for each issue that is reviewed by them and to provide a grade for any upcoming issues that are identified by a calendar of upcoming new issues. Qualified graders 104 may also be invited to initiate coverage of one or more Credit Related Securities and qualified graders 104 as a community may be asked to provide and identify those Credit Related Securities that they would like to see graded. Once those credit related securities are identified by the community they are added to the list of issues to be graded and circulated for evaluation and grading.

F. Grade Generation is the process of taking the mapped grades provided by the qualified graders 104, applying rules/instructions which are a function of grader experience, grader consistency, back testing for any adjustments to contributing grades and other factors to adjust a grade from a given qualified grader 104. The adjusted grades are then averaged to generate a single grade for each Credit Related Security.

G. Derivative is a contract that derives its value from the performance of an underlying entity. This underlying entity can be an asset, index, or interest rate, or may be a basket of assets and are often simply called the “underlying”. Derivatives can be used for a number of purposes, including insuring against price movements (hedging), increasing exposure to price movements for speculation or getting access to otherwise hard-to-trade assets or markets. For purposes of the description of a preferred embodiment of the invention, the assets shall be Credit Related Securities. However, derivatives may be generated to provide a basked of correlated or non-correlated risk or other variants, depending on the purpose for which the derivative is being generated.

H. Derivative Generation is the process by which credit grades for individual issues are uniquely aggregated through a derivative basket generator module 200 based on a basket of the individual grades. Each basket of credit grades will provide the market with an up-to-date measure of qualified grader 104 grades regarding the direction of creditworthiness for an entire fixed income market such as municipals, or various sub sectors, such as health care providers or state governments. Additionally, the derivative generation may be a function of alternate baskets or weighed baskets of related or uncorrelated issues depending on the particular derivative that is being generated and contracted for.

FIG. 1 is a block diagram overview of the analytics management environment 100 that includes a counterparty pool 102 from which qualified graders 104 are selected via a grader qualifying module 104A. The grader qualifying module 104A facilitates the analysis of market presence of the entity, measured by size of holdings or money under management and investment presence within market sectors. Those market sectors may be municipal bonds corporate bonds, asset backed sovereigns and other forms of credit related securities. Further elements of the criteria employed to determine whether the entity employs a formal credit approval and review process to determine valuation and credit worthiness of specific investments within the Credit Related Securities field.

It is important to note that while one of the criteria employed by the grader qualifying module 104A involves the determination of whether an entity employs a formal credit approval and review process it does not require that the qualified grader 104 divulge the specifics of that credit approval and review process. It is sufficient that such a process exists within the entity. Thus, inasmuch as most entities employ proprietary credit approval and review processes which are dissimilar in their functionality, the aggregate of the review processes employed by the qualified graders 104 will result in a benefit in the overall analysis since the grades ultimately generated will not be the result of similar credit approval and review processes but rather disparate processes.

In order to maintain anonymity the qualified graders 104 or aggregated in a qualified grader module 106 and are provided with listings of Credit related securities. Among the listing of credit related securities will be both those which are followed by one or more of the qualified grader 104 and others which are not followed. The same list will be provided to all qualified graders 104 who will be tasked to contribute a grade to all of those issues which they follow.

Additionally, the qualified graders 104 will be prompted by the covered issue module 108 to review new issues which are about to be priced and come to market. The covered issue module 108 will task the qualified graders 104 to initiate coverage of the new issues and to request that they contribute grades to each of those new issues that they are following. Similarly, the qualified graders 104 as a community or individually may request that the other qualified graders 104 provide grades for issues that are either not covered or followed or which do not appear among the listing of credit related securities provided by the covered issue module 108.

As shown, the analytics management environment 100 is in communication with one or more user devices 109 a, b, c, d-nth where each of the user devices 109 is operated by or on behalf of a qualified grader 104 or some additional reporting entity such as a third party provider of credit support including bond insurers and financial guarantors. Each user device 109 may be in communication with, store or otherwise have access to the grades provided by the analytics management environment 100 as well as having communication within access to both common databases and proprietary databases (not shown) from which it is deriving the grade generated by the qualify grader 104.

Each user device 109 may be in communication with, store, or otherwise have access to position data associated with one or more existing positions or holdings to be graded using system 100 in the portfolio of or followed by one or more of the qualified graders 104. For example, each user may input or otherwise access information related to current Credit Related Securities positions as well as counterparty specific collateral arrangements associated with those current Credit Related Securities positions. Further, each user may input or otherwise access new positions or changes to collateral arrangements and/or credit terms. In some embodiments, both existing and new Credit Related Securities are stored as position data. In some embodiments, position data also includes counterparty specific credit terms, including, for example: ratings dependent collateral schedules, optional early terminations, time based breaks, trade breaks, ratings based trade breaks, upfront margin, etc. In some embodiments, portions of this data may be retrieved from another source or datastore, such as credit terms data described further below.

Market data that each qualified grader 104 may use may include, for example, swap rates, foreign exchange rates, foreign exchange volumes, foreign exchange correlation data, etc. Market data may also include data for a number of different currencies (and, where relevant, such as for swap rates, a number of different tenors). In some embodiments, market data is retrieved from publicly available data sources such as Bloomberg or the like. In general, the use of publicly-available or market data helps to ensure that grading analyses performed using the credit approval and review process are independently repeatable.

Credit spread data may include, for example, CDS curves, specifying CDS levels for various tenors as well as override or counterparty marks for each tenor. Data identifying an associated pricing curve (generally equivalent to the sum of the sector mark and override or counterparty mark for each tenor) may also be retrieved or calculated. In some instances, credit spread data may be used by a qualified grader 104 operating a user device 109 (e.g., via one of the illustrative user interfaces shown below in conjunction with FIG. 1). In some embodiments, credit spread data may be retrieved from sources such as other market participants or other public sources of information.

Credit terms data may include, for example, information defining particular issues, groups of related issues, positions or other information that defines the Credit Related Securities. For example, for a swap, credit terms data may include information such as a deal identifier, a net unit, a net present value, an effective data, a maturity data, and pays and receives data (such as the currency, the notational value, tenor, coupon and spread, cap and floor, etc.). In some instances, credit terms data may be used by a qualified grader 104 operating a user device 109 (e.g., via one of the illustrative user interfaces shown below in conjunction with FIG. 1).

The qualified graders 104 are provided with a list of Credit related securities and particularly a listing of the largest outstanding fixed income issues and requested to contribute their existing grades to all of the issues which they follow. The qualified graders 104 are provided access to the list of credit related securities through their individual user device 109.

Each of the qualified graders 104 then provides their respective grade for each issue which they review to a contributed grade transfer module 110. The contributed grade transfer-module 110 communicates with a common scale mapping module 120 in order to permit the normalization of each of the contributed grades in accordance with a common scale of relative risk. By way of example only the common scale mapping module 120 is capable of generating a numeric scale with the strongest possible credit graded at a 10.0 while lesser quality credits Will be graded on a continuous scale ranging from 9.9 to 0.1. The common scale mapping module 120 thereby permits the grades provided by each of the qualified graders 104 to be normalized and employed to generate a single grade for each of the issues that are reviewed.

In addition to receiving grades from the qualified graders 104 the common scale mapping module 120 is connected to one or more third party contributor grading modules 125. The third party contributor grading modules 125 communicate with credit support entities such as bond insurers and financial guarantors who are solicited to provide grades for each of the issues which they can sure or guarantee. The common scale mapping module 120 also normalizes the grades provided by each of the bond insurers and financial guarantors in order to generate hey uniformly normalized set of grades generate the final grade for each followed issue.

The output of the common scale mapping module 120 is provided to a grade generation module 130 that aggregates the grades and applies an adjustment factor to the grades based upon and as a function of one or more of the following characteristics:

a. grader experience,

b. number of contributed grades,

c. grader consistency,

d. grader accuracy as a function of market bid ask spreads and sales prices,

e. grader adjustments as a function of the necessity of adjusting a particular grade over a period of time,

f. grader adjustments as a function of the necessity of adjusting a series of grades over a period of time,

g. changes in the market presence of a grader,

h. changes in the measurement of size of holdings or money under management and investment presence within a market sector of any grader.

Once the adjustment factor is applied to the grades they are aggregated (which may be averaging function or some other aggregation methodology appropriate to the particular issue or series of issues) and an overall grade is generated for each issue. Each overall grade for each issue is then provided to a counterparty database server 150 that may be accessed by counterparties who are qualified graders 140 through user devices 109 or to users 160 who are non-counterparty subscribers or otherwise provided access to the system through user devices or other means of electronic access.

Referring to FIGS. 1 and 2, there is depicted a derivative generation module 200 which communicates with the grade generation module 130. The gray generation module 130 provides output which is distributed to both the user distribution module 140 for use by user Devices 109 and to a derivative generation engine 205. The derivative generation engine 205 is comprised of a grade aggregation module 210 which receives the output from the grade generation module 130.

The individual grades may be aggregated by the grade aggregation module 210 to create a basket of Credit Related Securities according a specified categorization of the individual Credit Related Securities. Derivatives may be created therefrom to either hedge the basket or to permit the trading of the derivatives directly as contracts. Alternatively, specific derivatives may be created to permit the generation of alternative forms of contracts to satisfy specific investor requirements and needs.

Thus, by way of example, the grade aggregation module 210 may provide the aggregated data and grades to a basket generation module 215 to provide an overall grade for a specific basket of issues which are related, such as a series of municipal bonds issued by the same authority but with varying maturities, coupons, insurance profiles, guarantees and terms. Alternatively, the basket generation module may provide an overall grade for a specific basket of issues relating to healthcare or transportation as an example.

By way of a further example the grade aggregation module 210 may provide the aggregated data and grades to an alternate basket generation module 220 which may provide an overall grade for a basket of non-correlated issues in accordance with a specified directive or contract objective to create a specific derivative. That derivative may be uses a hedge against the alternate basket or may be traded directly as a contract.

Another example the grade aggregation module 210 may provide the aggregated data and grades to a weighted basket generation module 225 which may provide an overall grade by weighing various issues within the basket as a function of independent criteria such as securitization of the issue, governmental pronouncements relating to the issue, relationship to other similar issues, and such other criteria as may be determined in weighing me particular issues within the weighted basket. That weighted basket may then be use as a hedge or may be traded directly as a contract.

In still another example the grade aggregation module 210 may provide the aggregated data and grades to a special basket module 230 which may provided overall grade in accordance with specific criteria created via a user in order to satisfy a specific need or desire to create a special derivative. The special basket module 230 could be employed to generate a derivative which permitted the shortening of a specific market by creating a grade for that special basket of issues which represented the specific market to be shorted.

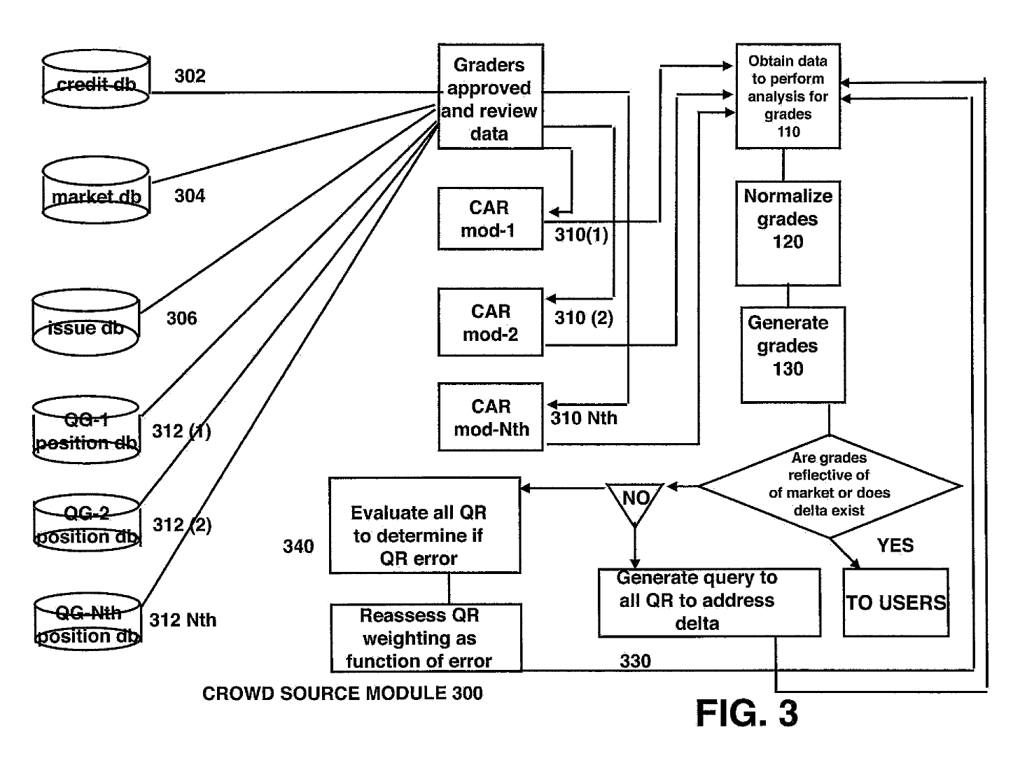

Referring now to FIG. 3, when taken in conjunction with FIGS. 1 and 2 there is shown a crowd source module 300 that is exemplary of the methodology, according to the invention, of the obtaining and use of grades. Each of the qualified graders 104 obtains credit market and issue data, among other items from both public credit databases 302, market databases 304, and issue databases 306 and private databases (not shown) which each of the qualified graders 104 regularly maintained as part of their database structure for following specific issues.

The qualified graders 104 also use their respective, independent credit approval and review modules 310 (1), 310 (2) . . . 310 (n) (also referred to as CAR 1-n) to obtain data from their respective position databases 312 (1), 312 (2) . . . 312 (n) and to each generate a grade for each issue which they follow. The grades are then transferred and communicated to the contributed grade module 110 which identifies grades related to similar issues and normalizes those grades via the grade mapping module 120. The communication may include an interface, logic, memory, and/or other suitable elements. The interface receives input, sentence output, processes the input and or output and/or performs other suitable operations. An interface may comprise hardware and/or software.

The grade mapping module 120 then transmits the grades for each respective issue to the grade generation module 130 which subsequently provides the grades to users. However, at the time that the grade generation module 130 provides the grades for each issue it also evaluates whether the grades are reflective of market, bid ask spreads and other market relevant criteria in order to generate queries and tasks via task generator 330 to all of the qualified graders 104 to address any discrepancies between a grade and a perceived market for that issue.

In addition to generating a query and task to the qualified graders 104, the crowd source module maintains an evaluation database module 340 which continuously updates and evaluates each of the qualified graders 104 to determine if any given qualified grader has provided a grade which is shown historically to be an outlier. In the event such occurs then there is a reassessment of the qualified grader and a concomitant modification of the weighing attributed to that qualify grader as a function of the perceived grading errors.

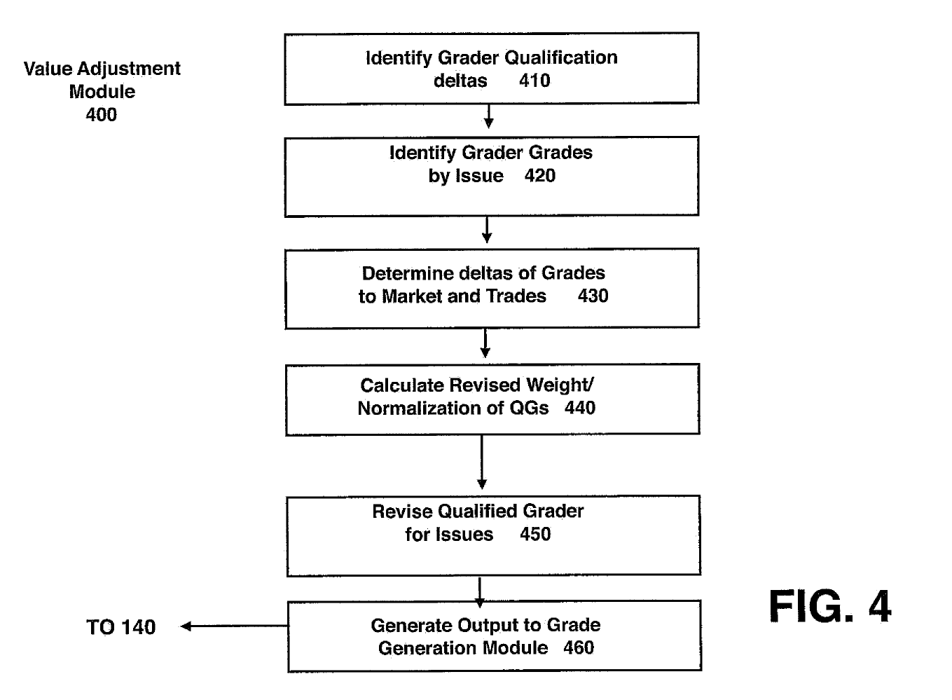

Referring now to FIG. 4 there is depicted a value adjustment module 400 by which the grades provided to each issue are regularly adjusted to provide up-to-date grades for each issue and for each basket of issues. Module 410 identifies a grader's qualifications and any differences in those qualifications as a function of time. Thus, if the qualified grader's positions change those differences are noted. Module 420 identifies a qualified grader' grades by issue so that any change will be solely related to the issues which a particular grader follows. Module 430 determines any difference between the grades provided by a qualified grader 104 and marketing trade consensus as to the value both in absolute terms and relative terms of a particular issue.

Module 440 calculates the revised weight normalization for any qualified grader 104. Module 450 revises a qualified grader 104 and the waiting to be provided and employed for any specific qualified grader 104 and generates a revised grade adjustment where appropriate. Module 460 receives data from module 450 and upon completion of the analysis creates a report and transmits any revised weighing for a particular qualified grader 104 to the grade generation module 130.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein, but may be modified within the scope and equivalents of the appended claims. Further, the present invention is not limited to the embodiments described above, and variations, substitutions, combinations of elements and derivative means and systems may be undertaken and implemented by those skilled in the art and are all within the scope of the claims set forth hereinafter.

What is claimed is:

1. A credit related securities valuation system, comprising:
a. a computer system comprising one or more processors and instructions that cause the computer system to obtain crowd-sourced information associated with at least one credit related security from a multiplicity of pre-selected crowd-sourced entities;
b. map the crowd-sources information as function of a multiplicity of pre-determined credit related reference criteria;
c. calculate a first reference grade for said credit related security for each selected entity;
d. normalize each first reference grade;
e. calculate a second reference grade based on the aggregate of the normalized grades to generate a relative and absolute risk grade for said credit related security; and,
f. output the relative and absolute risk grade.

2. A credit related securities valuation system in accordance with claim 1, wherein the crowd-sourced information is generated in and based upon real-time market data.

3. A credit related securities valuation system in accordance with claim 1, wherein the first reference grade is derived as a function of real-time data.

4. A credit related securities valuation system in accordance with claim 1, wherein the crowd-sourced information is generated in and based upon real-time market data from a multiplicity of pre-selected crowd-sourced entities on a blind basis relative to each of the members of the pre-selected entities.

5. A credit related securities valuation system, comprising:
a. a computer system comprising one or more processors, and one or more storage devices in communication with said computer system and storing instructions adapted to be executed by said computer system to obtain unstructured crowd-sourced information associated with at least one credit related security from a multiplicity of pre-selected crowd-sourced entities;
b. convert the unstructured data to structured data by mapping the crowd-sources information as function of a multiplicity of pre-determined credit related reference criteria;
c. calculate a first reference grade for said credit related security for each selected entity;
d. normalize each first reference grade;
e. calculate a second reference grade based on the aggregate of the normalized grades to generate a relative and absolute risk grade for said credit related security; and,
f. output the relative and absolute risk grade.

6. A credit related securities valuation system in accordance with claim 5, wherein the crowd-sourced information is generated in and based upon real-time market data.

7. A credit related securities valuation system in accordance with claim 5, wherein the first reference grade is derived as a function of real-time data.

8. A credit related securities valuation system in accordance with claim 5, wherein the crowd-sourced information is generated in and based upon real-time market data from a multiplicity of pre-selected crowd-sourced entities on a blind basis relative to each of the members of the pre-selected entities.

9. A derivative securities generation and valuation system, comprising:
g. a computer system comprising one or more processors and instructions that cause the computer system to obtain crowd-sourced information associated with at least one credit related security from a multiplicity of pre-selected crowd-sourced entities;
h. map the crowd-sources information as function of a multiplicity of pre-determined credit related reference criteria;
i. calculate a first reference grade for said credit related security for each selected entity;
j. normalize each first reference grade;
k. calculate a second reference grade based on the aggregate of the normalized grades to generate a relative and absolute risk grade for said credit related security;
l. generate a derivative securities contract as a function of the reference grades and pre-determined mapping reference points; and,
m. output the derivative.

10. A derivative securities generation and valuation system in accordance with claim 9, wherein the pre-determined mapping reference points generate weighted baskets of derivative securities.

11. A derivative securities generation and valuation system in accordance with claim 9, wherein the pre-determined mapping reference points are non-correlated points to generate derivative securities.
